(19) United States
(12) Patent Application Publication
(10) Pub. No.: US 2007/0295553 A1
(43) Pub. Date: Dec. 27, 2007

(54) Vehicle intake sound introducing apparatus

(76) Inventors: Daisuke Ochi, Isehara-shi (JP); Noriaki Yamamoto, Isehara-shi (JP); Hisayoshi Matsuoka, Aikou-gun (JP)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/820,775

(22) Filed: Jun. 20, 2007

(30) Foreign Application Priority Data
Jun. 21, 2006 (JP) 2006-171288

(51) Int. Cl. G10K 11/18

(52) U.S. Cl. 181/18

(57) ABSTRACT

An intake sound introducing apparatus is disclosed. An intake sound introducing apparatus may include a lining member attached to a lower surface of a bonnet hood. The lining member may generally define a communication passage. The communication passage may include an engine compartment side opening and a dash panel side opening.

### CROSS-REFERENCE TO RELATED APPLICATIONS

This application claims priority from Japanese Patent Application Serial No. 2006-171288 filed Jun. 21, 2006, the disclosure of which, including its specification, drawings and claims, are incorporated herein by reference in its entirety.

### FIELD

The disclosure relates to an apparatus for introducing an engine intake sound to a vehicle, thereby improving sound quality of the intake sound generated from an engine intake system of the vehicle, for example, and more particularly, to an apparatus for introducing a vehicle intake sound to a vehicle that enhances layout freedom.

### BACKGROUND

Various types of vehicle intake sound introducing apparatuses are known. For example, a vehicle intake sound introducing apparatus is disclosed in published Japanese Patent Application No. 2004-218458. The intake sound introducing apparatus disclosed therein couples a side-wall opening of an outside-air introducing part of an intake passage to an engine with the upper part of a dash panel located relatively close to a driver's seat of the vehicle with a flexible tube. The flexible tube must be located in an engine compartment. Accordingly, the system takes up space within the engine compartment, and may be difficult to install in vehicles having small engine compartments, or engine compartments already crowded with various vehicle and engine hardware.

### SUMMARY

According to various embodiments, an apparatus and a method for introducing an intake sound into a vehicle cabin is disclosed. An exemplary embodiment of an intake introducing apparatus includes a communication passage disposed along a longitudinal direction of a vehicle in the engine compartment. The communication passage includes an engine compartment side opening and a dash panel side opening. A lining member attached to a lower surface of a bonnet hood covering the engine compartment forms at least a portion of the communication passage.

### BRIEF DESCRIPTION OF THE DRAWINGS

While the claims are not limited to the illustrated embodiments, an appreciation of various aspects is best gained through a discussion of various examples thereof. Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limiting or restricting to the precise form and configuration shown in the drawings and disclosed in the following detailed description. Exemplary embodiments of the present invention are described in detail by referring to the drawings as follows.

FIG. 1 is a top view of a vehicle having an intake sound introducing apparatus according to a first embodiment;

FIG. 2 is a side view of a vehicle having an intake sound introducing apparatus;

FIG. 3 is a cross-sectional view of a lining member mounted to a bonnet hood of a vehicle, taken along line III-III in FIG. 1;

FIG. 4 is an enlarged view of detail circle V of FIG. 2;

FIG. 5 is an enlarged view of detail circle VI of FIG. 2;

FIG. 6 is an enlarged view showing an embodiment of detail circle VI that includes an air-box side shielding member;

FIG. 7 is a cross-sectional view showing a lining member mounted to a bonnet hood, according to an embodiment;

FIG. 8 is a cross-sectional view showing a lining member mounted to a bonnet hood, according to an embodiment;

FIG. 9 is a cross-sectional view showing a lining member mounted to a bonnet hood, according to an embodiment;

FIG. 10 is a cross-sectional view of an intake sound introducing apparatus, according to a second embodiment;

FIG. 11 is a cross-sectional view of a secondary communication-passage forming member, according to an embodiment;

FIG. 12 is a side view of an intake sound introducing apparatus, according to a third embodiment;

FIG. 13 is a schematic diagram of a system for controlling a phase of a sound output from a secondary sound source, according to an embodiment;

FIG. 14 is a graph showing a relationship between a crank angle signal S1 and a throttle-valve opening degree signal S2, according to an embodiment;

FIG. 15A is a diagram showing a configuration of an output voltage control map, according to an embodiment; and

FIG. 15B is a diagram showing a configuration of a phase control map, according to an embodiment.

### DETAILED DESCRIPTION

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

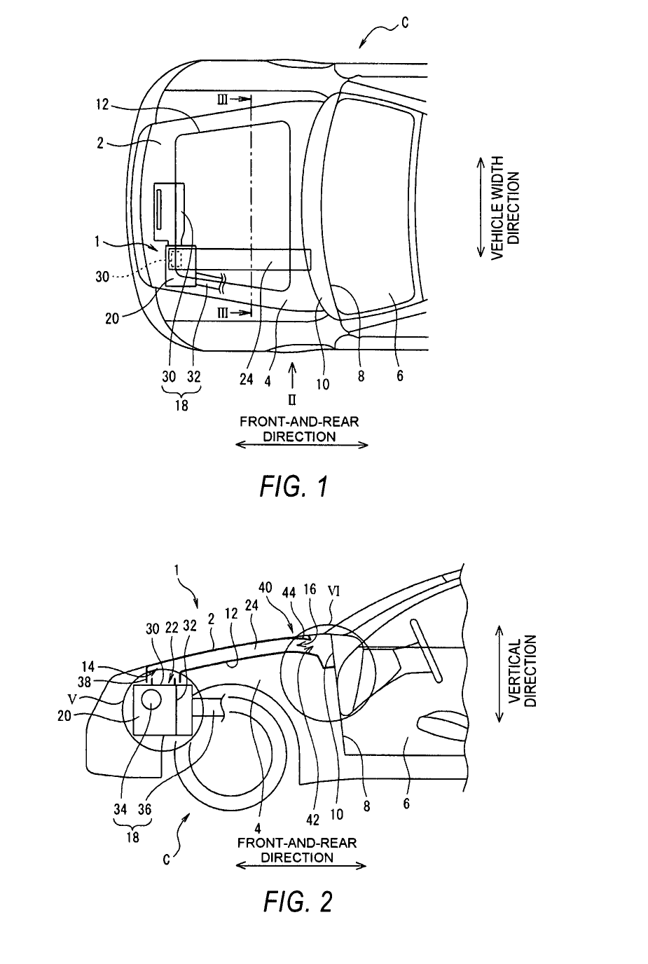

Turning now to FIGS. 1 and 2, a vehicle C is illustrated having an intake sound introducing apparatus 1, according to an embodiment. As shown in FIGS. 1 and 2, intake sound introducing apparatus I of the embodiment is located in an engine compartment 4 having a bonnet hood 2 in a closed position. Engine compartment 4 is located in front of a cabin 6 as viewed in the front-and-rear direction of the vehicle, and is separated from the cabin 6 with a dash panel 8 interposed therebetween. An air box 10 may be mounted to an upper part of a surface of the dash panel 8 within engine compartment 4.

The bonnet hood 2 may be mounted to vehicle C in any known manner. Bonnet hood 2 preferably is mounted such that it may be opened for access to the engine compartment, and closed to shield the engine compartment from the ambient environment, such as during operation of vehicle C. A lining member 12 is mounted on a lower surface of bonnet hood 2.

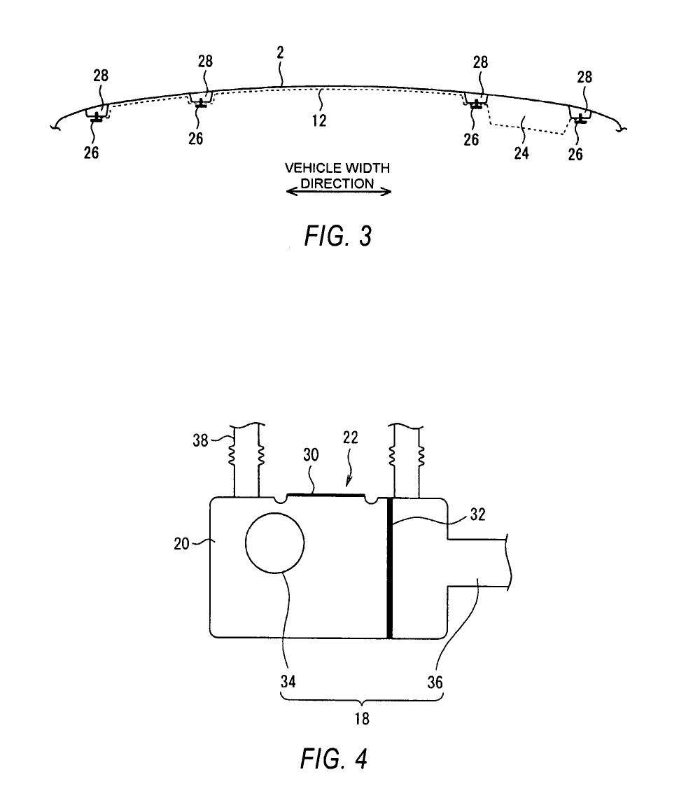

Turning now to FIG. 3, lining member 12 is shown in further detail. Lining member 12 is preferably formed with a sound absorbing material, e.g., compressed felt. Accordingly, lining member 12 may be constructed of a material that generally absorbs frequencies, especially such frequencies that may be unpleasant to vehicle occupants. However, any known material may be employed for lining member 12. A part of the lining member 12 is extended downward to form a gap between the lining member and the bonnet hood 2. Lining member 12 thus cooperates with bonnet hood 2 to form a communication passage 24 having an engine-compartment side opening 14 disposed within engine compartment 4 and a dash-panel side opening 16 disposed adjacent an air box 10. The engine compartment opening 14 may be in fluid communication with an intake-passage side opening 22 of an air cleaner 20. The air cleaner 20 may be installed to an intake duct 18 serving as an intake passage receiving outside air for an engine (not shown). The dash-panel side opening 16 of communication passage 24 may be disposed adjacent the dash panel 8, and is preferably disposed adjacent air box 10. As shown in FIG. 3, the lining member 12 may be mounted on the lower surface of the bonnet hood 2 with a plurality of fasteners 26. A plurality of mounts 28, to which the tips of the fasteners 26 are attached, may be formed on the lower surface of the bonnet hood 2.

Lining member 12 may be formed in any known processes for manufacturing known lining members. For example, lining member 12 may be molded. Lining member 12 may be press molded such that a portion of the lining member 12 extends downward to cooperate with the bonnet hood 2 to form communication passage 24. Accordingly, a portion of lining member 12 which forms communication passage 24 may be generally integrally formed with lining member 12.

Conveniently, a gap between the bonnet hood 2 and the engine may provide beneficial pedestrian safety characteristics to vehicle C as a result of the increased space between bonnet hood 2 and the engine (not shown).

Turning now to FIG. 4, air cleaner 20 is described in further detail. As shown in FIG. 4, the intake-passage side opening 22 may be covered or sealed with an elastic film member 30. The elastic film member 30 may take a shape of a disc made of, for example, an elastic material such as rubber. The elastic film member 30 elastically deforms at least in a vertical direction (relative to FIGS. 2 and 4) according to variations of an intake pressure in an intake duct 18 communicating with air cleaner 20, such as during an intake stroke of the engine.

The air cleaner 20 may include a filter part 32, for example, an oiled filter. Outside air may generally pass through air cleaner 20 during operation of vehicle C, and is drawn into the engine after being filtered by the air filter 32. The intake duct 18 may include a dust side intake duct 34 and a clean side intake duct 36. Dust side intake duct 34 generally allows fluid communication between outside or ambient air and air filter 32, while clean side intake duct 36 generally allows fluid communication between air filter 32 and the engine (not shown). Accordingly, air drawn into air cleaner 20 is passed through air filter 32, thereby generally preventing contaminants from being drawn into the engine.

One or more engine-compartment side shielding members 38 may be disposed between the engine-compartment side opening 14 and the intake-passage side opening 22 of communication passage 24. When bonnet hood 2 is closed, the engine-compartment side shielding members 38 generally provide a seal between the engine-compartment side opening 14 and the intake-passage side opening 22, thereby generally preventing outside air from intruding into communication passage 24.

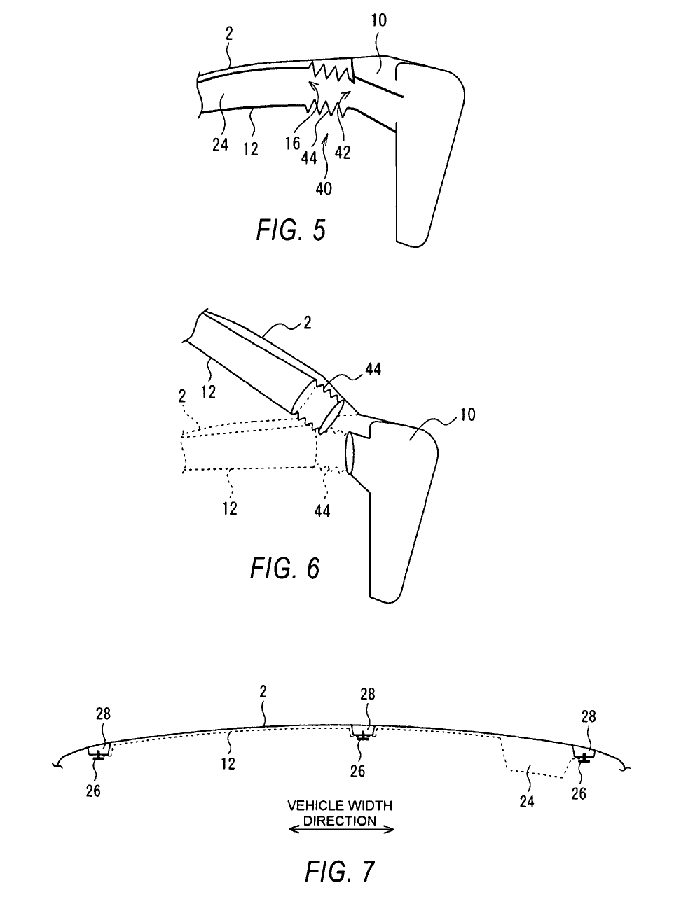

Turning now to FIG. 5, an air-box side communication member 40 is shown disposed between the dash-panel side opening 16 of communication passage 24 and the peripheral surface of the air box 10. The air-box side communication member 40 generally allows for fluid communication between the dash-panel side opening 16 of communication passage 24 and an air-box side opening 42 formed in air box 10. The air-box side communication member 40 may have an air-box side shielding member 44 that is shaped like a bellows, and is flexible in an axial direction and across its width. One or both ends of the air-box side shielding member 44 may be fixed to the lining member 12 and/or the air box 10. The air-box side shielding member 44 may thereby generally allow fluid communication between the dash-panel side opening 16 of communication passage 24 and the air-box side opening 42, while generally preventing intrusion of outside air.

Operation of the intake sound introducing apparatus 1 will now be described in further detail. During an intake stroke of the engine, air is drawn into air cleaner 20 through the dust side intake duct 34, passing through the air filter 32, and to the clean side intake duct 36. The cleaned air is then drawn into a cylinder (not shown) of the engine.

As is generally known, the engine generates an intake pulsation in the air communicating with the clean side intake duct 36 as a natural effect of the operation of the engine. The intake pulsation thus propagates an intake sound in and around the engine. The intake pulsation generated by the intake operation of the engine generally includes a plurality of intake pulsation components having different frequencies.

The intake pulsation generated in the clean side intake duct 36 as a result of the intake operation of the engine generally propagates from the clean side intake duct 36 to the air cleaner 20. Elastic film member 30 elastically vibrates or deforms in accordance with the intake pulsation.

When the elastic film member 30 is deformed by the intake pulsation, especially in a vertical direction as shown in FIGS. 2 and 4, the intake pulsation communicates with the engine-compartment side opening 14 as a result of the seal provided by the engine-compartment side shielding member 38. Accordingly, the intake pulsation is efficiently propagated to the communication passage 24.

The engine-compartment side shielding member 38 isolates the space formed between the engine-compartment side opening 14 and the intake-passage side opening 22 from outside air. The result is that undesirable noise, e.g., engine noise present within engine compartment 4, is generally prevented from propagating to the communication passage 24. Additionally, high temperature air present in the engine compartment 4 is generally prevented from being introduced into the communication passage 24.

The intake pulsation may therefore propagate from the engine intake system to communication passage 24. Since communication passage 24 generally freely allows fluid communication between engine-compartment side opening 14 and dash-panel side opening 16, the intake pulsation therefore generally is propagated to the dash-panel side opening 16 from engine-compartment side opening 14.

The intake pulsation may further propagate from the dash-panel side opening 16, through the air-box side communication member 40, and into the air-box side opening 42, reaching air box 10 and the interior or cavity defined therein. The air-box side shielding member 44 may generally seal the interface between the dash-panel side opening 16 and the air-box side opening 42 from outside air. As a result, the intake sound and/or intake pulsation, which passes through the air-box side opening 42 by way of the air-box side communication member 40, is prevented from radiating to the outside air or environment. Additionally, air-box side communication member 40 generally prevents high temperature air present in the engine compartment 4 from being introduced into the air-box 10. When the intake pulsation has propagated to the air box 10, the intake sound and/or intake pulsation propagates to the cabin 6 via the dash panel 8, thereby introducing vigorous exhaust sounds into the cabin 6.

Accordingly, intake sound introducing apparatus allows for the efficient introduction of desirable engine intake sounds into the cabin 6 of vehicle C. Additionally, various lining members are generally known and used in a wide variety of vehicles. Accordingly, a lining member 12 may be provided that takes up little, if any, additional space in the engine room, and generally does not add significant numbers of parts or complexity to vehicle C.

As generally described above, the air-box side shielding member 44 of air-box side communication member 40 may be generally flexible along its axis and width, and the ends of the air-box side shielding member 44 may be fixed to the lining member 12 and the air box 10. However, alternative embodiments may include an air-box side shielding member 44 that is fixed at only one end to the lining member 12, while the other end thereof is not fixed to the air box 10, as shown, for example, in FIG. 6. In this case, with the bonnet hood 2 opened, the space formed between the dash-panel side opening 16 and the air-box side opening 42 is opened to outside air. Only when the bonnet hood 2 is closed is the space formed between the dash-panel side opening 16 and the air-box side opening 42 isolated from outside air. Accordingly, air-box side shielding member 44 provides a seal between air box 10 and lining member 12 when bonnet hood 2 is closed, but does not constrain the articulation of bonnet hood 2 between an open position and a closed position. However, air-box side communication member 40 may be provided without an air-box side shielding member 44. While the air-box side shielding member 44 generally prevents the intake sound and/or intake pulsation from being radiated directly to the outside air, and from introducing higher temperature air present in the engine compartment 4 from being introduced into the air-box side communication member 40, air-box side shielding member 44 is not required.

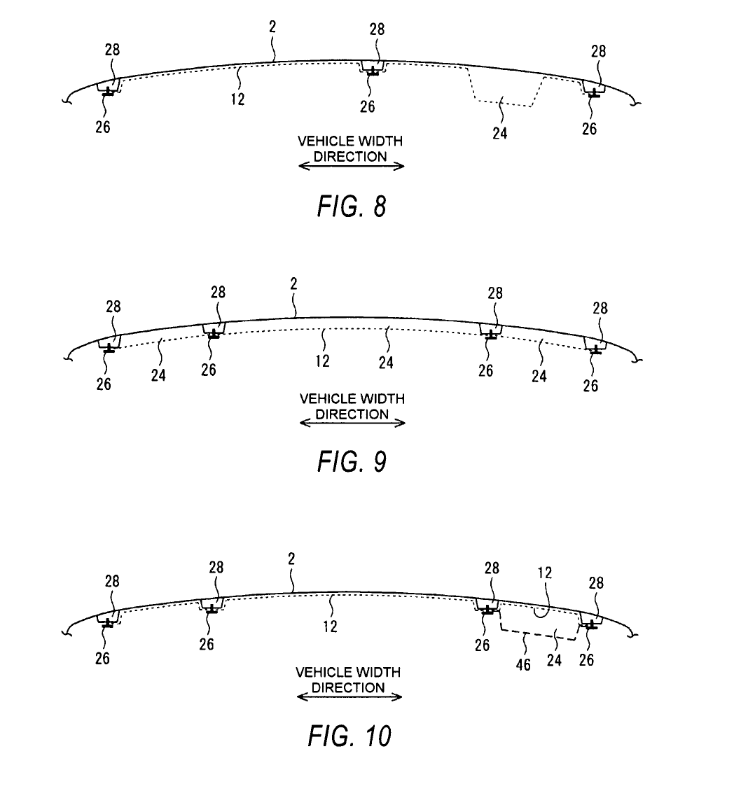

As described above, the lining member 12 may be secured to bonnet hood 2 with fasteners 26 secured to mounts 28 located on either side of the communication passage 24. However, lining member 12 may also be formed with a relatively high rigidity across the width of vehicle C such that fewer fasteners 26 may be employed to secure lining member 12 to bonnet hood 2. For example, as shown in FIG. 7, fasteners 26 may be located immediately adjacent communication passage 24 on one side of communication passage 24 of lining member 12. Further, other embodiments are possible wherein fasteners 26 secure lining member 12 to bonnet hood 2 without being located immediately adjacent to either side of communication passage 12, as shown in FIG. 8.

As described above, lining member 12 may define a communication passage 24 that is located in a particular portion or region of lining member 12. However, other shapes of communication passage 12 may be defined. In fact, the lining member 12 may be arranged such that the communication passage 24 generally extends across the entire width of the bonnet hood 2, as shown in FIG. 9. Accordingly, a wide variety of embodiments are possibly that employ at least a portion of the lining member 12 to form a communication passage 24, wherein at least a part of the wall of the communication passage 24 is formed with the lining member 12.

Although the engine-compartment side shielding member 38 has been described above as being located between the engine-compartment side opening 14 and the intake-passage side opening 22, engine-compartment side shielding member 38 is not required. The engine-compartment side shielding member 38 generally promotes efficient propagation of the intake sound and/or intake pulsation to the communication passage 24 by preventing ambient noise from being introduced into the cabin 6, and high temperature air present in the engine compartment 4 from being introduced into communication passage 24. However, it may be convenient to provide the intake sound introducing apparatus without engine-compartment side shielding member 38 to simplify the overall construction and assembly of intake sound introducing apparatus 1.

As described above, the air box 10 is attached directly to the dash panel 8 within the engine compartment 4. However, air box 10 need not be directly attached to the dash panel 8, or even be located within the engine compartment 4. Securing air box 10 directly to the dash panel 8 within the engine compartment 4 promotes efficient propagation of the intake sound into the cabin 6, but other surfaces of the vehicle may be employed for installation of air box 10, while offering similarly efficient sound propagation characteristics.

As described above, the air-box side opening 42 may be disposed in a peripheral surface of the air box 10, and may be generally oriented toward the dash-panel side opening 16 of communication passage 24. However, the air-box side opening 42 need not be located on the surface of air box 10 as explicitly described herein. While providing the air-box side opening 42 in a peripheral surface of the air box 10 may improve propagation of the intake sound from communication passage 24 into the air box 10, air-box side opening 42 may be received in any part of air box 10.

As described above, intake-passage side opening 22 may be generally sealed or blocked with the elastic film member 30. However, elastic film member 30 may be eliminated, such that intake-passage side opening 22 is opened to the outside air. While elastic film member 30 generally prevents high temperature air present in the engine compartment 4 from entering the air cleaner 20, it is not required, and may be eliminated to simplify construction and/or assembly of the intake sound introducing apparatus.

As described above, the intake-passage side opening 22 is received in the air cleaner 20. However, the intake-passage side opening 22 may be formed in any peripheral surface of the clean side intake duct 36 instead.

While the lining member 12 has been described herein as being located in the front of the cabin 6 the lining member 12 may be arranged at any other position in the vehicle according to the location of engine compartment 4. For example, where the engine compartment 4 is located on the rear side of the cabin 6, the lining member 12 may be located in the engine compartment 4 on the rear side of a cabin 6. Further, where the engine compartment 4 is located under the cabin 6, the lining member 12 may be located in the engine compartment 4 under the cabin 6. Thus, the location of lining member 12 may be changed according to the arrangement of the vehicle, and specifically the location of the engine compartment 4.

Turning now to FIG. 10, an intake sound introducing apparatus 1 is illustrated according to a second embodiment. Intake sound introducing apparatus 1 is substantially the same as that of the first embodiment except a communication-passage forming member 46 is additionally included that is attached to the under surface of the lining member 12. The communication-passage forming member 46 may be mounted to the bonnet hood 2 with a plurality of fasteners 26.

Turning now to FIG. 11, communication-passage forming member 46 is described in further detail. A portion of communication-passage forming member 46 may extend downward to define a gap between the communication-passage forming member and the lining member 12. Accordingly, communication passage forming member 46 cooperates with at least one surface of lining member 12 to define a communication passage 24. The lining member 12 may be shaped, as a whole, in conformity with a shape of the bonnet hood 2, and mounted on the under surface of the bonnet hood 2 with a plurality of fasteners 26. A plurality of mounts 28 to which fasteners 26 are attached may be provided on a lower surface of the bonnet hood 2. Communication passage 24 may otherwise be generally similar to the embodiments described above. Further, intake sounds and/or intake pulsations may generally be propagated through communication passage 24 as described above. This second embodiment of intake sound introducing apparatus 1 may advantageously allow use of an existing lining member 12, as opposed to forming features within lining member 12 itself to provide a communication passage 24. Further, use of a communication passage forming member 46 generally decreases propagation of intake noise and/or intake pulsations through the bonnet hood 2. Accordingly, communication passage forming member 46 may decrease ambient noise created by a vehicle, and more efficiently introduce desirable engine intake sounds into the cabin 6 of vehicle C.

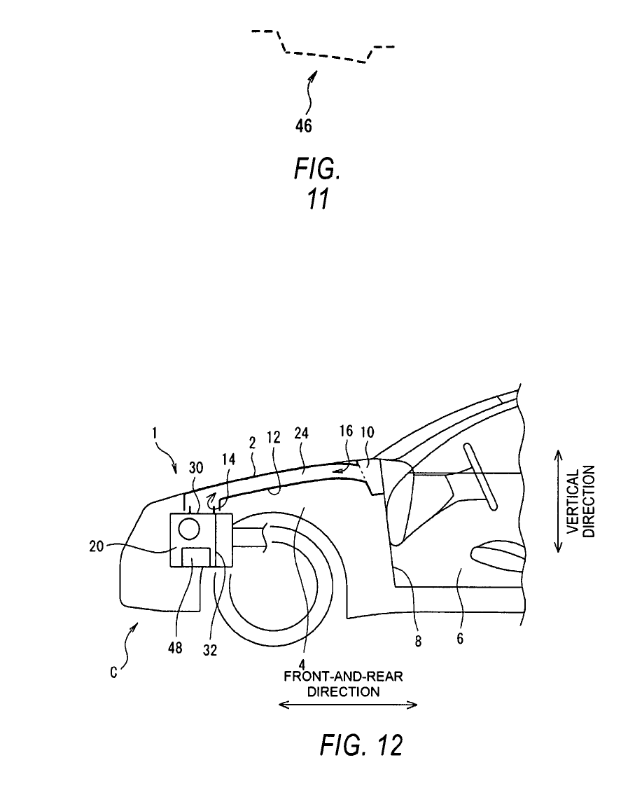

Turning now to FIG. 12, an intake sound introducing apparatus 1 is shown having a secondary sound source 48 located in the air cleaner 20, and a phase control device (not shown in FIG. 12) in communication with secondary sound source 48. The secondary sound source 48 may include any device capable of generating a sound, such as a speaker. The secondary sound source 48 is operable to output a sound in phase with or opposite in phase to the intake pulsation generated by the engine in the clean side intake duct 36 to the communication passage 24. The secondary sound generated by the secondary sound source 48 may be directed upward, or in any direction such that the sound may be received in or propagated in the communication passage 24, such as at engine-compartment side opening 14. A phase of the secondary sound output from the secondary sound source 48 may be controlled by the phase control device.

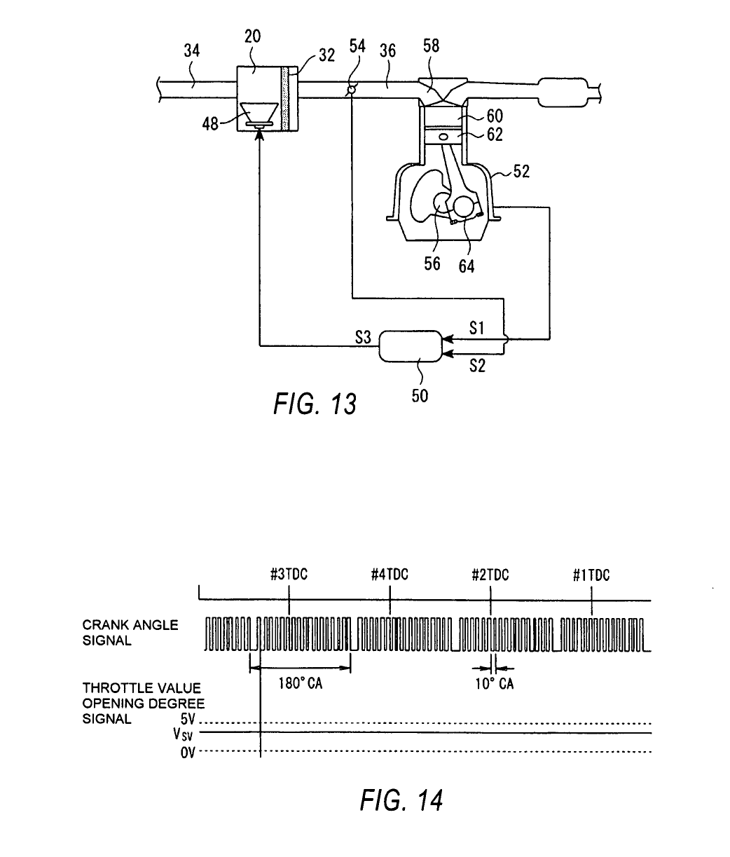

Turning now to FIG. 13, the phase control device 50 is shown connected to a crank-shaft angle sensor (not shown) mounted to an engine 52, a throttle opening degree sensor (not shown) mounted to a throttle valve 54, and the secondary sound source 48. The crank-shaft angle sensor is generally operable to detect a crank angle position from a rotor (not shown) provided on a crank shaft 56, and generate a crank angle signal S1 which is transmitted to the phase control device 50. The throttle opening degree sensor is operable to detect an opening degree of the throttle valve 54, and transmit a voltage signal based on the sensed opening degree of the throttle valve 54 as a throttle-valve opening degree signal S2 to the phase control device 50.

The throttle valve 54 may be located between the air cleaner 20 and the intake port 58 and coupled to an accelerator pedal (not shown). As is generally known, the throttle valve 54 incrementally or decrementally controls an amount of air to an intake port 58 from the air cleaner 20 in accordance with a position of the accelerator pedal. When the position of the accelerator pedal is adjusted to decrease the amount of air to the intake port 58 from the air cleaner 20, e.g., a vehicle operator takes their foot from the pedal, a rotational speed of the engine 52 decreases. When the position of the accelerator pedal is adjusted to increase the amount of air to the intake port 58 from the air cleaner 20, e.g., a vehicle operator pushes downward on the accelerator pedal, the rotational speed of the engine 52 increases.

During the intake stroke, intake air is supplied to a cylinder 60 via the intake port 58, e.g., the air that is introduced through the dust side intake duct 34 and cleaned by the air cleaner 20, and present in the clean side intake duct 36.

When receiving the crank angle signal S1 and the throttle-valve opening degree information signal S2, the phase control device 50 detects or determines a driving state of the engine 52 from the information contained in those signals. The phase control device 50 may determine a phase of the output sound on the basis of values read out from an output voltage control map and a phase control map.

The phase control device 50 generates an output sound, which may be in phase with or opposite in phase to the intake pulsation in the clean side intake duct 36. The phase control device is generally operable to generate an output sound signal S3 causing the desired output sound to be outputted to the secondary sound source 48. Accordingly, the phase control device 50 may generally control a phase of the output sound in accordance with a driving state of the engine 52 to create a desired intake sound and/or pulsation.

When the engine 52 is in a slow acceleration state where the rotational speed of the engine 52 is relatively slow, the phase control device 50 may generate an output sound in phase with or opposite in phase to the intake pulsation in the clean side intake duct 36. When the engine 52 is a quick acceleration state where the rotational speed of the engine 52 is faster, the phase control device 50 may generate an output sound in phase with the intake pulsation in the clean side intake duct 36. Generation of an output sound may be altered in various embodiments to be in phase or out of phase with the intake pulsation, according to a particular application.

Turning now to FIG. 14, a graph showing a relationship between the crank angle signal S1 and the throttle-valve opening degree signal S2 is illustrated, according to an embodiment. As shown in FIG. 14, the crank angle signal S1 contains a group of pulse signals each having a pulse width corresponding to 10° crank angle (CA) of a rotation of the crank shaft 56 (to be referred to as “crank angle”), and a bottom-dead-center signal SC which recurs at intervals each corresponding to 180° CA of the crank angle. The bottom-dead-center signal SC is used for determining a rotational position of the crank shaft 56. The signal indicates that the piston 62 is positioned at or near the bottom dead center position, in the cylinder 60. Accordingly, the crank angle signal S1 is a signal enabling the detection of the number of rotations of the engine 52 and the rotational positions of the crank shaft 56. The top-dead-center (TDC) positions are located at four positions in the figure to indicate that the piston 62 is at the top dead center position, wherein a connecting rod 64 and the crank shaft 56 are generally aligned with each other.

The throttle-valve opening signal S2 may be represented in the form of a voltage signal Vsv indicating the opening degree of the throttle valve 54, thereby indicating increases or decreases in accordance with an opening degree of the throttle valve 54. The upper limit value of the voltage signal Vsv may be set to any standard value, e.g., 5 Volts (V), while the lower limit value thereof may be set at any other standard value, e.g., zero (0) V.

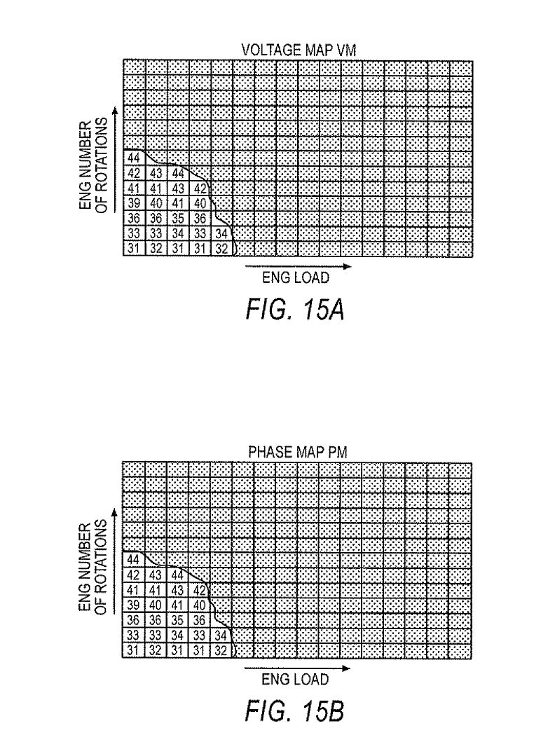

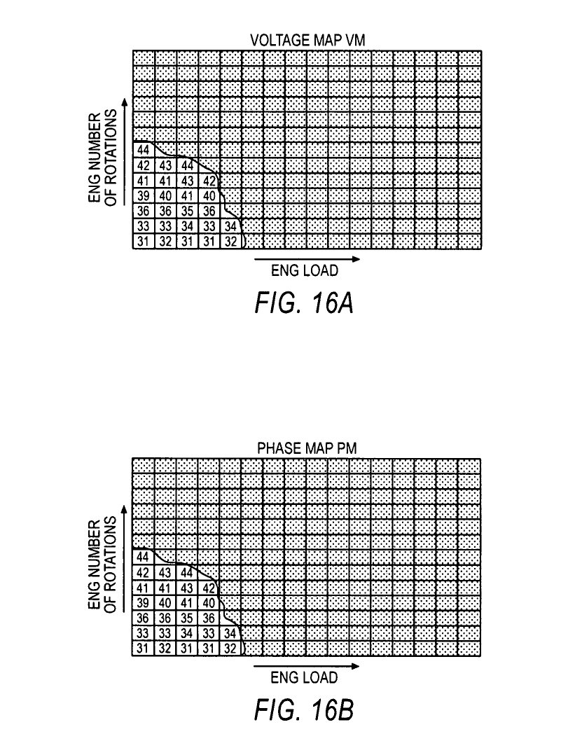

Turning now to FIGS. 15A and 15B, a voltage control map and a phase control map are illustrated, respectively, according to an embodiment. In FIG. 15A, the output voltage control map is described as “voltage map VM”, while the phase control map in FIG. 15B is described as “phase map PM”. Generally, the abscissa plotted in the voltage map and the phase map represents a rotational speed of the engine (=“ENG number of rotations” in the figure), while the ordinate represents a load of the engine (=“ENG load” in the figure). As described above, the rotational speed of the engine on the abscissa may be determined from signal S1, while the load of the engine may be determined from signal S2.

The voltage map VM and the phase map PM are each generally constructed with a lattice having a number of open spaces. Each open space contains a particular desired phase based on the voltage signals, which depend on the rotational speed of the engine 52 and the opening degree of the throttle valve 54. Various embodiments of voltage map VM and phase map PM may be employed according to a particular application, and whether it is desired to increase or decrease the intake sound of the engine at a particular engine state. Accordingly, the intake sound characteristic may be set according to particular vehicle characteristics, the taste of a vehicle owner, etc.

Accordingly, when the engine 52 is driven, the crank shaft angle sensor attached to the engine 52 detects a signal wave from the rotor provided in association with the crank shaft 56. A pulse signal contained in the detected signal wave is sent as a crank angle signal S1 representative of an angle of the crank shaft to the phase control device 50. A throttle opening degree sensor attached to the throttle valve 54 detects an opening degree of the throttle valve 54, and sends a voltage signal based on the detected opening degree of the throttle valve 54 as a throttle-valve opening degree signal S2 representative of an opening degree of the throttle valve 54 to the phase control device 50.

Upon receipt of the crank angle signal S1 and the throttle-valve opening degree signal S2, the phase control device 50 detects or determines a driving state of the engine 52 from information contained in those signals (see FIG. 13).

The phase control device 50 may therefore detect a bottom dead center signal SC contained in the crank angle signal S1, i.e., a signal every 180° CA of the crank angle, and may use a trailing edge of the signal of the first pulse after the bottom dead center signal SC as a phase reference signal for the output sound. The phase control device 50 may calculate a rotational speed of the engine 52 from the period at which the bottom dead center signal SC is generated.

The phase control device 50 further detects a voltage signal Vsv corresponding to an opening degree of the throttle valve 54 and contained in the throttle-valve opening signal S2. The phase control device 50 may read the phases described in the voltage map VM and the phase map PM in accordance with the voltage signal, which depends on the rotational speed of the engine 52 and the opening degree of the throttle valve 54, to determine the desired phase of the secondary sound source.

The phase control device 50 may further signal the secondary sound source 48 to generate the output sound, i.e., the desired phase sound output determined from the engine operating state, in the clean side intake duct 36, with an output sound signal S3. Upon receipt of the output sound signal S3, the secondary sound source 48 may output the desired output sound, which may be in phase with or opposite in phase to the intake pulsation in the clean side intake duct 36, from the air cleaner 20 to the engine-compartment side opening 14.

Accordingly, when the engine is being driven, the intake pulsation generated in the clean side intake duct 36 during the intake stroke of the engine is propagated from the clean side intake duct 36 to the air cleaner 20, and the elastic film member 30 elastically deforms in the its surface-outside directions according to the intake pulsation having been propagated to the air cleaner 20. The intake pulsation having been prompted by the elastic deformation of the elastic film member 30 to be propagated to the air cleaner 20 propagates through the engine-compartment side shielding member 38 and the engine-compartment side opening 14 and reaches the communication passage 24.

At this time, the output sound, which is in phase with or opposite in phase to the intake pulsation in the clean side intake duct 36, is output from the secondary sound source 48 located in the air cleaner 20 to the engine-compartment side opening 14. When the phase of the output sound output from the secondary sound source 48 is out of phase with the intake pulsation in the clean side intake duct 36, the output sound generally cancels out the intake pulsation in the clean side intake duct 36. As a result, the intake sound by the intake pulsation is substantially reduced, or even eliminated. When the output sound from the secondary sound source 48 is in phase with the intake pulsation in the clean side intake duct 36, the output sound and the intake pulsation in the clean side intake duct 36 are superposed on each other, thereby amplifying the intake sound level. The amplified intake sound propagates through the air box 10 and the dash panel 8 and enters the cabin 6. This introduces a vigorous intake sound into the cabin 6.

As described above, the secondary sound source 48 is located in the air cleaner 20. However, the secondary sound source 48 may be located in any position which allows the output sound to be introduced from the secondary sound source 48 into the communication passage 24. For example, the secondary sound source 48 may be located in the communication passage 24.

In the intake sound introducing apparatus 1 of the embodiment, the driving state of the engine 52 is based on the angle of the crank shaft 56 and the opening degree of the throttle valve 54. If desired, the driving state of the engine 52 may be determined from other factors, e.g., the vehicle speed.

The output sound phase is not limited to the generally automatic phase setting described above. For example, a switch may be provided within vehicle C such that a driver may manually control the phase of the output sound propagated to the communication passage 24. Accordingly, when the driver desires a quieter driving experience, e.g., during slow acceleration or cruising, he/she operates the switch so that the output sound output to the communication passage 24 is opposite in phase to the intake pulsation in the clean side intake duct 36, thereby substantially reducing or eliminating the intake sound. When the driver desires a greater intake sound level, e.g., when the driver is engaged in more spirited driving, he/she may operate the switch so that the output sound output to the communication passage 24 is in phase with the intake pulsation in the clean side intake duct 36, thereby amplifying the intake sound introduced into the cabin 6.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain approaches, examples or embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A method for communicating an intake sound of a vehicle with a cabin of the vehicle, comprising:
passing the intake sound through a communication passage;
wherein at least part of the communication passage is formed with a lining member attached to a surface of a bonnet hood covering an engine compartment.

2. An apparatus for introducing an intake sound into a vehicle cabin, comprising:
a communication passage disposed along a longitudinal direction of a vehicle in the engine compartment, wherein the communication passage includes an engine compartment side opening and a dash panel side opening;
wherein a lining member attached to a lower surface of a bonnet hood covering the engine compartment forms at least a portion of the communication passage.

3. The apparatus of claim 2, wherein the communication passage is disposed between the bonnet hood and the lining member.

4. The apparatus of claim 3, further comprising:
an air box secured to the dash panel, the air box defining a cavity; and
an air-box communication member operable to allow fluid communication between the cavity and the dash-panel side opening of the communication passage.

5. The apparatus of claim 3, further comprising an intake passage in fluid communication with an engine, the intake passage having an intake-passage side opening disposed adjacent the engine-compartment side opening.

6. The apparatus of claim 5, further comprising an engine compartment side shielding member operable to allow fluid communication between the engine compartment side opening and the intake-passage side opening, the engine compartment side shielding member operable to generally seal an interface between the engine-compartment side opening and the intake-passage side opening.

7. The apparatus of claim 5, further comprising an elastic film member operable to generally seal the intake-passage side opening, the elastic film member operable to elastically deform according to a pressure variation in the intake passage.

8. The apparatus of claim 2, further comprising:
a secondary communication-passage forming member disposed on a surface of the lining member;
wherein the communication passage is disposed between the lining member and the secondary communication-passage forming member.

9. The apparatus of claim 8, further comprising:
an air box mounted on the dash panel, the air box having a cavity; and
an air-box side communication member for allowing communication between the air box and the dash-panel side opening of the communication passage.

10. The apparatus of claim 9, further comprising an air-box side shielding member disposed in the air-box side communication member, the air-box side shielding member operable to generally prevent intrusion of outside air into an interface between the air-box side communication member and the dash-panel side opening of the communication member when the bonnet hood is in a closed position.

11. The apparatus of claim 8, further comprising an intake passage in fluid communication with an engine, the intake passage having an intake-passage side opening located adjacent the engine compartment side opening.

12. The apparatus of claim 11, further comprising an engine-compartment side shielding member operable to allow fluid communication between the engine-compartment side opening and the intake-passage side opening, the engine-compartment side shielding member operable to generally seal an interface between the engine-compartment side opening and the intake-passage side opening.

13. The apparatus of claim 11, further comprising an elastic film member operable to generally seal the intake-passage side opening, the elastic film member operable to elastically deform according to a pressure variation in the intake passage.

14. The apparatus of claim 11, further comprising:
a secondary sound source operable to generate a sound in the intake passage; and
phase control device for controlling a phase of a sound output from the secondary sound source.

15. The apparatus of claim 14, further comprising:
crank angle detecting sensor for detecting an angle of a crank shaft; and
throttle-valve opening degree detecting sensor for detecting an opening degree of a throttle valve, wherein the phase control device controls a phase of a sound output from the secondary sound source according to at least the crank angle and the throttle-valve opening degree.

16. A lining member attached to a lower surface of a bonnet hood covering an engine compartment from above, wherein the lining member forms at least a part of a communication passage operable to allow fluid communication between an engine compartment side opening of the communication passage adjacent the engine compartment and a dash-panel side opening of the communication passage opened to a panel of a vehicle cabin.

17. An intake sound introducing apparatus for a vehicle, comprising:
a means for providing fluid communication between an engine compartment and a panel of a vehicle cabin;
wherein the means for providing fluid communication is attached to a lower surface of a bonnet hood covering the engine room from above, the means for providing fluid communication including at least a portion of a lining member for the bonnet hood.
